(19) United States
(12) Patent Application Publication
(10) Pub. No.: US 2025/0349309 A1
(43) Pub. Date: Nov. 13, 2025

(54) Audio Processing to Reduce Feedback

(71) Applicant: Anker Innovations Technology Co., Ltd., Changsha (CN)

(72) Inventors: Rui Zhu, Shenzhen (CN); Jianqiang Wei, Shenzhen (CN)

(21) Appl. No.: 19/201,438

(22) Filed: May 7, 2025

(30) Foreign Application Priority Data
May 8, 2024 (CN) 202410564386.2

(51) Int. Cl. G10L 21/0264; G10L 21/0208; G10L 21/0216; G10L 21/0232

(52) U.S. Cl. CPC G10L 21/0264; G10L 21/0232; G10L 2021/02082; G10L 2021/02165

(57) ABSTRACT

Disclosed are an audio processing method and device, an audio apparatus, and a computer-readable storage medium for reducing a probability of a howling phenomenon of an audio apparatus. The method may be applied to an audio apparatus provided with a feedforward microphone, a feedback microphone, and/or an adaptive feedback canceller. Aspects described herein may comprise acquiring a first sound signal collected by the feedforward microphone and a second sound signal collected by the feedback microphone; detecting coherence change information between the first sound signal and the second sound signal, and updating canceller parameters of the adaptive feedback canceller according to the coherence change information; and/or performing echo cancellation on a pre-played audio signal of the audio apparatus according to the updated canceller parameters to obtain an actually played audio of the audio apparatus.

### CROSS-REFERENCE TO RELATED APPLICATION

The present application claims priority to Chinese Patent Application No. 202410564386.2, filed on May 8, 2024, which is herein incorporated by reference by its entirety.

### FIELD

The present disclosure relates to the technical field of sound processing. More particularly, aspects described herein may relate to audio processing, an audio processing device/apparatus, and/or an audio processing storage medium.

### BACKGROUND

With the development of sound processing technologies, a howling phenomenon, sometimes referred to as feedback, may occur in an audio apparatus. For example, a microphone may receive an external sound source signal, which is amplified in power, propagated out from a speaker, and then fed back to the microphone to form a closed amplification loop, and when such feedback meets certain oscillation conditions, a sharp and harsh sound may be generated.

The howling phenomenon is sometimes addressed based on an adaptive feedback cancellation (AFC) module, which is usually a filter with adaptively updated parameters. A feedback sound signal of a feedback path from the speaker to the microphone might be estimated in real time using the AFC module. The feedback sound signal may be subtracted from an audio signal that the speaker needs to play, for example, echo cancellation is performed, which can avoid the howling phenomenon.

However, the AFC module has a process of tracking parameter estimation, for example, the estimated parameters of the AFC module may vary with the feedback path from the speaker to the microphone. If the feedback path from the speaker to the microphone varies drastically, the AFC module might not track parameter estimation properly, for example, the estimated parameters of the AFC module might not vary rapidly in time in response to the drastic change of the feedback path, and thus the echo cancellation might not be thorough enough when the feedback path from the speaker to the microphone changes drastically. This can result in the howling phenomenon (e.g., feedback).

### SUMMARY

To address the issues disclosed above, as well as others, aspects described herein relate to an audio processing method and device, an audio apparatus, and a computer-readable storage medium capable of reducing a probability of the howling phenomenon of an audio apparatus.

Aspects described herein may provide an audio processing method applied to an audio apparatus provided with a feedforward microphone, a feedback microphone and an adaptive feedback canceller. This method may comprise acquiring a first sound signal collected by the feedforward microphone and a second sound signal collected by the feedback microphone; detecting coherence change information between the first sound signal and the second sound signal, and updating canceller parameters of the adaptive feedback canceller according to the coherence change information; and/or performing echo cancellation on a pre-played audio signal of the audio apparatus according to the updated canceller parameters to obtain an actually played audio of the audio apparatus.

The detecting coherence change information between the first sound signal and the second sound signal may comprise converting the first sound signal into a first frequency-domain signal; converting the second sound signal into a second frequency-domain signal; and/or generating coherence change information according to coherence information between the first frequency-domain signal and the second frequency-domain signal.

The generating the coherence change information according to coherence information between the first frequency-domain signal and the second frequency-domain signal may comprise determining coherence extremum information at a current moment from the coherence information between the first frequency-domain signal and the second frequency-domain signal according to time delay range information between the feedforward microphone and the feedback microphone; and/or generating coherence change information according to the coherence extremum information at the current moment and coherence extremum information at a previous moment.

The generating the coherence change information according to coherence information between the first frequency-domain signal and the second frequency-domain signal may comprise determining a current moment when the first sound signal and the second sound signal are collected; calculating coherence information between the first frequency-domain signal and the second frequency-domain signal at the current moment; and/or differentiating a coherence value at the current moment and coherence information at a previous moment to obtain coherence change information.

The updating the canceller parameters of the adaptive feedback canceller according to the coherence change information may comprise determining parameter update information of the adaptive feedback canceller according to the coherence change information; and/or updating canceller parameters of the adaptive feedback canceller according to the parameter update information which is used to control an update rate of the canceller parameters.

The parameter update information may comprise at least one of an update coefficient and an update step size; and the determining the parameter update information of the adaptive feedback canceller according to the coherence change information may comprise at least one of the following: mapping the coherence change information into the update coefficient according to a first preset mapping relationship, wherein the update coefficient is used to characterize a proportion of canceller parameters before update to the updated canceller parameters; and/or mapping the coherence change information into an update step size of the canceller parameters at a current moment according to a second preset mapping relationship.

The performing the echo cancellation on a pre-played audio signal of the audio apparatus according to the updated canceller parameters to obtain an actually played audio of the audio apparatus may comprise estimating a feedback sound signal at a current moment according to the updated canceller parameters and an actually played audio of the audio apparatus at a previous moment; and/or differentiating the feedback sound signal and the pre-played audio signal of the audio apparatus to obtain an actually played audio of the audio apparatus at the current moment.

Aspects described herein may further provide an audio processing device applied to an audio apparatus provided with a feedforward microphone, a feedback microphone, and/or an adaptive feedback canceller. That device may comprise an acquisition module configured to acquire a first sound signal collected by the feedforward microphone and a second sound signal collected by the feedback microphone; a parameter update module configured to detect coherence change information between the first sound signal and the second sound signal and update canceller parameters of the adaptive feedback canceller according to the coherence change information; and/or an echo cancellation module configured to perform echo cancellation on a pre-played audio signal of the audio apparatus according to the updated canceller parameters to obtain an actually played audio of the audio apparatus.

Aspects described herein may further provide an audio apparatus. The audio apparatus may comprise a feedforward microphone, a feedback microphone, an adaptive feedback canceller, a memory, and/or a processor. The memory may store a computer program. The processor may perform one or more of the following steps when executing the computer program: acquiring a first sound signal collected by the feedforward microphone and a second sound signal collected by the feedback microphone; detecting coherence change information between the first sound signal and the second sound signal, and updating canceller parameters of the adaptive feedback canceller according to the coherence change information; and/or performing echo cancellation on a pre-played audio signal of the audio apparatus according to the updated canceller parameters to obtain an actually played audio of the audio apparatus.

Aspects described herein may further provide a computer-readable storage medium comprising a computer program. The computer program may perform one or more of the following steps when executed by a processor: acquiring a first sound signal collected by the feedforward microphone and a second sound signal collected by the feedback microphone; detecting coherence change information between the first sound signal and the second sound signal, and updating canceller parameters of the adaptive feedback canceller according to the coherence change information; and/or performing echo cancellation on a pre-played audio signal of the audio apparatus according to the updated canceller parameters to obtain an actually played audio of the audio apparatus.

Aspects described herein may further provide a computer program product comprising a computer program. The computer program may perform one or more of the following steps when executed by a processor: acquiring a first sound signal collected by the feedforward microphone and a second sound signal collected by the feedback microphone; detecting coherence change information between the first sound signal and the second sound signal, and updating canceller parameters of the adaptive feedback canceller according to the coherence change information; and/or performing echo cancellation on a pre-played audio signal of the audio apparatus according to the updated canceller parameters to obtain an actually played audio of the audio apparatus.

Aspects described herein may be configurable to provide flexible and substantially real-time feedback cancellation. The first sound signal collected by the feedforward microphone and/or the second sound signal collected by the feedback microphone may be acquired. Then, coherence change information between the first sound signal and the second sound signal may be detected. Since the coherence between the first sound signal and the second sound signal may be related to the feedback path from the speaker to the microphone, when the feedback path changes, the signal coherence between the first sound signal and the second sound signal might also change correspondingly. Therefore, the coherence change information may characterize intensity of the change of the feedback path, such that that updating the canceller parameters of the adaptive feedback canceller according to the coherence change information may realize flexible and real-time adjustment of the canceller parameters according to the change intensity of the feedback path, thus realizing the real-time tracking of the parameter estimation of the adaptive feedback canceller, which can ensure that the parameter estimation of the adaptive feedback canceller can be tracked properly. Therefore, performing the echo cancellation on the pre-played audio signal of the audio apparatus according to the updated canceller parameters may avoid a situation where the echo cancellation is not thorough when the feedback path from the speaker to the microphone changes drastically, thus reducing a probability of the howling phenomenon of (e.g., a feedback sound from) the audio apparatus.

### BRIEF DESCRIPTION OF THE DRAWINGS

FIG. 1 is a schematic flowchart of an audio processing method;

FIG. 2 is a schematic flowchart of generating coherence change information;

FIG. 3 is a schematic flowchart of generating coherence change information;

FIG. 4 is a structure block diagram of an audio processing device; and

FIG. 5 is an internal structure diagram of an audio apparatus.

### DETAILED DESCRIPTION

In order to make the objects, technical solutions, and advantages of the present disclosure clearer, the present disclosure may be further described in detail below and, for example, with reference to the drawings. It should be understood that the examples provided herein are only used to explain the disclosure, but are not intended to limit the disclosure.

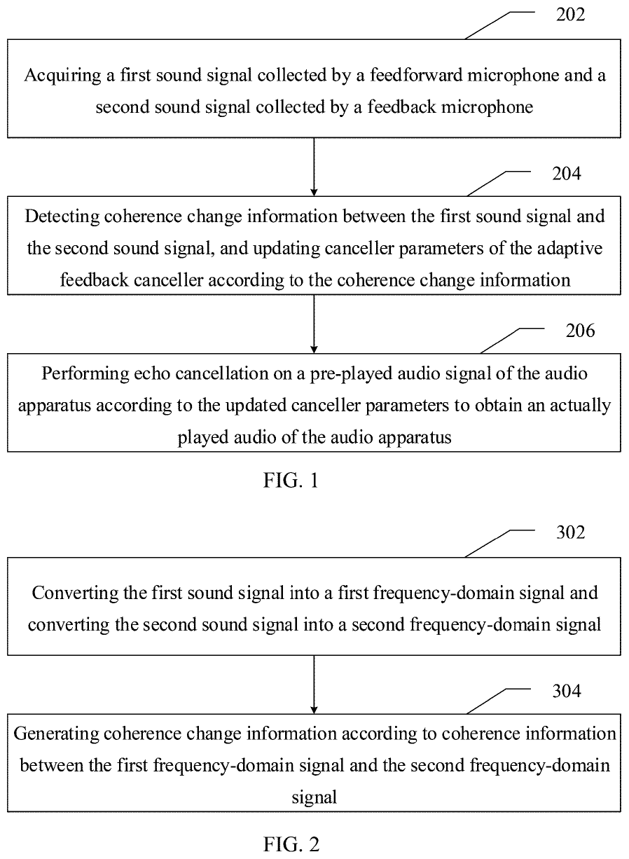

FIG. 1 depicts an audio processing method that may be performed by and/or with respect to an audio apparatus. The audio apparatus may comprise a feedforward microphone, a feedback microphone, and/or an adaptive feedback canceller. The audio processing method includes following steps 202 to 206.

Step 202 may comprise acquiring a first sound signal collected by the feedforward microphone and/or a second sound signal collected by the feedback microphone. The audio apparatus may be a hearing aid device or an earphone, and the audio apparatus may be provided with, for example, one or more of: a feedforward microphone, a feedback microphone, a speaker, a calling microphone, an adaptive feedback canceller, and the like. As an example, the adaptive feedback canceller may be an AFC module which is configured to estimate a feedback sound signal of a feedback path from the speaker to the microphone in real time, so that the feedback sound signal can be subtracted from an audio signal that the speaker plays; for example, echo cancellation can be performed, which may avoid the howling phenomenon.

Step 204 may comprise detecting coherence change information between the first sound signal and the second sound signal and/or updating canceller parameters of the adaptive feedback canceller according to the coherence change information. The first sound signal and the second sound signal may be time domain framing signals; fore example, the first sound signal can be l₁ frames of time-domain signals collected by the feedforward microphone, and the second sound signal can be l₂ frames of time-domain signals collected by the feedback microphone. l₁ and l₂ are positive integers and can be equal or unequal.

As an example, step 204 may include converting the first sound signal from a time domain to a frequency domain to obtain a first frequency-domain signal and/or converting the second sound signal from a time domain to a frequency domain to obtain a second frequency-domain signal; calculating a coherence value of the first frequency-domain signal and the second frequency-domain signal at a current time frame; determining coherence change information of the coherence value changing over time according to a difference between the coherence value at the current time frame and a coherence value at a previous time frame; and/or updating the canceller parameters of the adaptive feedback canceller according to the coherence change information.

As an example, the coherence change information may comprise a change amplitude of the coherence value, for example, a coherence change amplitude. The greater the change amplitude of the coherence value, the lager the change of the feedback path from the speaker to the microphone might be. For example, when a user changes from wearing earphones to not wearing earphones, the feedback path from the speaker to the microphone might change drastically, for example, the coherence between the first sound signal collected by the feedforward microphone and the second sound signal collected by the feedback microphone might change greatly. When the user holds a hearing aid, the user's hand may block the feedback path from the speaker to the microphone, so that the feedback path from the speaker to the microphone will change drastically, for example, the coherence between the first sound signal collected by the feedforward microphone and the second sound signal collected by the feedback microphone might also change greatly.

Updating the canceller parameters of the adaptive feedback canceller according to the coherence change information may include determining parameter update information of the adaptive feedback canceller according to the coherence change information; and/or updating the canceller parameters of the adaptive feedback canceller according to the parameter update information. The parameter update information may be used to control an update rate of the canceller parameters.

The parameter update information may be used to control the update rate of the canceller parameters, and can be an update step size or an update coefficient. The update step size may be a step size for updating the canceller parameters of the adaptive feedback canceller. For example, the larger the update step size, the higher the update rate of the canceller parameters may be; and the smaller the update step size, the lower the update rate of the canceller parameters might be. The update coefficient may be a proportion of the canceller parameters before update to the updated canceller parameters. For example, the larger the update coefficient, the larger the proportion of the canceller parameters before update to the updated canceller parameters may be, and the lower the update rate of the canceller parameters; and the smaller the update coefficient, the smaller the proportion of the canceller parameters before update to the updated canceller parameters may be, and the higher the update rate of the canceller parameters may be.

The coherence change information may be mapped into the parameter update information according to a preset mapping relationship. The parameter update information may be used to control the update rate of the canceller parameters. The canceller parameters of the adaptive feedback canceller may be updated in real time according to the parameter update information.

Step 206 may comprise performing echo cancellation on a pre-played audio signal of the audio apparatus according to the updated canceller parameters to obtain an actually played audio of the audio apparatus. As an example, step 206 may include estimating a feedback sound signal on the feedback path from the speaker to the microphone at the current time frame according to the updated canceller parameters; and/or subtracting the feedback sound signal from the pre-played audio signal of the audio apparatus to obtain an actually played audio of the audio apparatus at the current time frame.

As an example, steps 202 to 206 may be repeated in the next time frame, which can track parameter estimation of the adaptive feedback canceller in real time over a time length, and the parameter update rate of the adaptive feedback canceller may change in real time with change intensity of the feedback path.

Performing echo cancellation on a pre-played audio signal of the audio apparatus according to the updated canceller parameters to obtain an actually played audio of the audio apparatus may include estimating a feedback sound signal at a current moment according to the updated canceller parameters and/or an actually played audio of the audio apparatus at a previous moment; and/or differentiating the feedback sound signal and the pre-played audio signal of the audio apparatus to obtain an actually played audio of the audio apparatus at the current moment.

The actually played audio of the audio apparatus at the previous moment may be filtered according to the updated canceller parameters to obtain the feedback sound signal at the current moment; and/or the feedback sound signal may be subtracted from the pre-played audio signal of the audio apparatus, and/or amplification may be performed to obtain the actually played audio of the audio apparatus at the current moment.

In the above audio processing method, the first sound signal collected by the feedforward microphone and/or the second sound signal collected by the feedback microphone may be acquired. Then, coherence change information between the first sound signal and the second sound signal may be detected. Since the coherence between the first sound signal and the second sound signal may be related to the feedback path from the speaker to the microphone, when the feedback path changes, the signal coherence between the first sound signal and the second sound signal may also change correspondingly. Therefore, the coherence change information may characterize intensity of the change of the feedback path, so that updating the canceller parameters of the adaptive feedback canceller according to the coherence change information can realize flexible and real-time adjustment of the canceller parameters according to the change intensity of the feedback path. This may realize the real-time tracking of the parameter estimation of the adaptive feedback canceller, which can ensure that the parameter estimation of the adaptive feedback canceller can be always tracked properly. Therefore, performing the echo cancellation on the pre-played audio signal of the audio apparatus according to the updated canceller parameters may avoid a situation where the echo cancellation is not thorough when the feedback path from the speaker to the microphone changes drastically. This may reduce a probability of the howling phenomenon of the audio apparatus.

As shown in FIG. 2, detecting the coherence change information between the first sound signal and the second sound signal may include steps 302 and 304.

Step 302 may comprise converting the first sound signal into a first frequency-domain signal, and/or converting the second sound signal into a second frequency-domain signal. The first sound signal can be a time-domain framing signal collected by the feedforward microphone at the current moment, for example, the current moment is divided into a plurality of time frames to obtain a first time-domain signal in the plurality of time frames. The second sound signal can be a time-domain framing signal collected by the feedback microphone at the current moment, for example, the current moment is divided into a plurality of time frames to obtain a second time-domain signal in the plurality of time frames.

As an example, the first time-domain signal in the plurality of time frames may be converted from the time domain to the frequency domain to obtain the first frequency-domain signal; and/or the second time-domain signal in the plurality of time frames may be converted from the time domain to the frequency domain to obtain the second frequency-domain signal.

As an example, if signal collection is performed at a moment n, the first sound signal is x₁(n), and the second sound signal is x₂(n), after the first sound signal x₁(n) is converted into frequency domain, the first frequency-domain signal may be X₁(m, l), and after the second sound signal x₂(n) is converted into frequency domain, the second frequency-domain signal may be X₂(m, l), where m is a frequency point, and l is the number of frames in the plurality of time frames. Step 304 may comprise generating coherence change information according to coherence information between the first frequency-domain signal and the second frequency-domain signal.

As an example, step 304 may include calculating a coherence value between the first frequency-domain signal and the second frequency-domain signal for each of the time frames of the current moment to obtain coherence information between the first frequency-domain signal and the second frequency-domain signal at the current moment; and/or calculating a first-order differential value changing over time between the coherence information at the current moment and coherence information at a previous moment to obtain the coherence change information. The current moment may be a moment when the first sound signal and the second sound signal are collected, and the previous moment may be a moment before the current moment, which can be a last moment of the current moment or a moment before the current moment which is spaced apart from the current moment by a preset number of moments.

As another example, step 304 may include calculating the coherence information of the first frequency-domain signal and the second frequency-domain signal for each of the time frames of the current moment; and/or calculating a first-order differential value changing over time between adjacent coherence information to obtain the coherence change information.

As an example, a calculation formula of the coherence information may be as follows:

$${τ}_{l} ( k ) = \frac{{φ}_{{X}_{1} {X}_{2}} ( k , l )}{\sqrt{{φ}_{{X}_{1} {X}_{2}} ( k , l ) {φ}_{{X}_{2} {X}_{2}} ( k , l )}}$$

$${φ}_{{X}_{i} {X}_{j}} ( k , l ) = {\sum }_{m} {X}_{i} ( m , l ) {X}_{j} ( m , l )$$

where τ₁(k) is coherence information in a time frame l, k is the current moment, m is a frequency point, Xᵢ(m, l) is a first frequency-domain signal at the frequency point m in the time frame l, and X; (m, l) is a second frequency-domain signal at the frequency point m in the time frame l.

Generating coherence change information according to the coherence information between the first frequency-domain signal and the second frequency-domain signal may include determining the current moment when the first sound signal and the second sound signal are collected; calculating coherence information between the first frequency-domain signal and the second frequency-domain signal at the current moment; and/or differentiating a coherence value at the current moment and coherence information at a previous moment to obtain coherence change information.

Specifically, a collecting moment when the feedforward microphone collects the first sound signal and the feedback microphone collects the second sound signal may be taken as the current moment; coherence between the first frequency-domain signal and the second frequency-domain signal at the current moment may be calculated to obtain the coherence information at the current moment; the coherence information at the previous moment is acquired, and the coherence information at the current moment and the coherence information at the previous moment may be differentiated, and/or a differentiated result may be taken as the coherence change information.

By converting the first sound signal into the first frequency-domain signal and converting the second sound signal into the second frequency-domain signal, then determining the current moment when the first sound signal and the second sound signal are collected, calculating the coherence information of the first frequency-domain signal and the second frequency-domain signal at the current moment, and differentiating the coherence value at the current moment and the coherence information at the previous moment to obtain the coherence change information, the signal coherence between the sound signals collected by the feedforward microphone and the feedback microphone may be accurately detected, which lays a foundation for adjusting the canceller parameters of the adaptive feedback canceller.

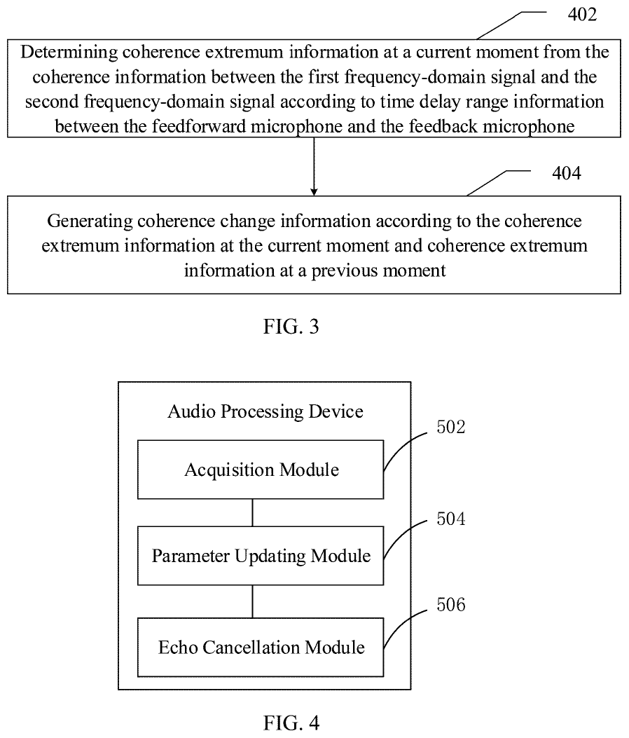

As shown in FIG. 3, generating the coherence change information according to the coherence information between the first frequency-domain signal and the second frequency-domain signal may include following steps 402 and 404.

Step 402 may comprise determining coherence extremum information at the current moment from the coherence information between the first frequency-domain signal and the second frequency-domain signal according to time delay range information between the feedforward microphone and the feedback microphone.

Due to influence of circuit design and feedback path between the feedforward microphone and the feedback microphone, there may be a certain time delay between sound signals collected by the feedforward microphone and the feedback microphone, which is usually within several time frames. For example, the time delay range information can be 0 to 5, which may indicate that the time delay may be 5 time frames. A target time frame can be any time frame in the current moment.

As an example, the step 402 may include randomly selecting a time frame from the current moment when the first sound signal and the second sound signal are collected as the target time frame; selecting a signal in the target time frame from the first frequency-domain signal as a first target frequency-domain signal; locating time frames to be selected corresponding to the target time frame according to the time delay range information between the feedforward microphone and the feedback microphone; taking frequency-domain signals in the second frequency-domain signals corresponding to the time frames to be selected as second target frequency-domain signals; separately calculating a plurality of pieces of coherence information between the first target frequency-domain signal and the second target frequency-domain signals; returning to perform the step of selecting a signal in the target time frame from the first frequency-domain signal as a first target frequency-domain signal until a plurality of pieces of coherence information in all of the target time frames in the current moment are obtained; and/or selecting coherence information with a maximum coherence value from all of the coherence information as the coherence extremum information.

As an example, a formula for separately calculating the plurality of pieces of coherence information between the first target frequency-domain signal and the second target frequency-domain signals may be as follows:

$${τ}_{l} ( k ) = \frac{{φ}_{{X}_{1} {X}_{2}} ( k , l )}{\sqrt{{φ}_{{X}_{1} {X}_{2}} ( k , l ) {φ}_{{X}_{2} {X}_{2}} ( k , l )}}$$

$${φ}_{{X}_{i} {X}_{j}} ( k , l ) = {\sum }_{m} {X}_{i} ( m , l + α ) {X}_{j} ( m , l )$$

where τ₁(k) is coherence information in a target time frame l, k is the current moment, m is a frequency point, Xᵢ(m, l) a first frequency-domain signal at the frequency point m in the time frame l, Xⱼ(m, l) is a second frequency-domain signal at the frequency point m in the time frame l+α, and α is a value within the time delay range between the feedforward microphone and the feedback microphone.

Step 404 may comprise generating the coherence change information according to coherence extremum information at the current moment and coherence extremum information at a previous moment.

As an example, step 404 may include calculating a first-order differential value changing over time between the coherence extremum information at the current moment and the coherence extremum information at the previous moment to obtain the coherence change information. The time delay between the feedforward microphone and the feedback microphone may be considered during detecting coherence change information between signals collected by the feedforward microphone and the feedback microphone, and thus detection accuracy of the coherence change information may be higher, which may facilitate improving accuracy of adjusting the update rate of the canceller parameters of the adaptive feedback canceller.

Determining the parameter update information of the adaptive feedback canceller according to the coherence change information may include mapping the coherence change information into the update coefficient according to a first preset mapping relationship, in which the update coefficient is used to characterize the proportion of the canceller parameters before update to the updated canceller parameters.

The adaptive feedback canceller may be a Kalman filter, and the parameter update information may be an update coefficient in a state update equation of the Kalman filter. The coherence change information may have a fixed first preset mapping relationship with the update coefficient, and thus as long as the coherence change information is known, the corresponding update coefficient may be calculated.

As an example, the first preset mapping relationship may be as follows:

$${A}_{l} = \frac{a}{b + {e}^{- {δ}_{l}}}$$

where Aₗ is an update coefficient at the frequency point l, a and b are known parameters, and δ₁ is coherence change information at the frequency point l, for example, a coherence change amplitude, which has a value of 0 to 2.

As an example, where a coherence change value in the coherence change information is in a coherence change value interval, an update coefficient corresponding to the coherence change value interval can be searched according to a corresponding relationship between the coherence change value interval and the update coefficient. For example, it may be set that a coherence change value interval (a1, a2) corresponds to an update coefficient H₁, a coherence change value interval (a2, a3) corresponds to the update coefficient H₂, and the like.

The parameter update information may include the update coefficient, and determining the parameter update information of the adaptive feedback canceller according to the coherence change information may include mapping the coherence change information into an update step size of the canceller parameters at the current moment according to a second preset mapping relationship.

The second preset mapping relationship may characterize a mapping relationship between the coherence change information and the update step size, and the coherence change information may be normalized to the update step size of the canceller parameters at the current moment according to the second preset mapping relationship.

As an example, where the coherence change value in the coherence change information is in the coherence change value interval, an update step size corresponding to the coherence change value interval may be searched according to a corresponding relationship between the coherence change value interval and the update step size. For example, it may be set that a coherence change value interval (a1, a2) corresponds to an update step size L₁, a coherence change value interval (a2, a3) corresponds to the update step size L₂, and the like.

The first sound signal collected by the feedforward microphone and the second sound signal collected by the feedback microphone may be acquired; the first sound signal may be converted into a first frequency-domain signal and the second sound signal may be converted into a second frequency-domain signal; the time frame may be randomly selected from the current moment when the first sound signal and the second sound signal are collected as the target time frame; and the signal at the target time frame may be selected from the first frequency-domain signal as a first target frequency-domain signal.

Further, time frames to be selected corresponding to the target time frame may be located according to the time delay range information between the feedforward microphone and the feedback microphone; frequency-domain signals in the second frequency-domain signals corresponding to the time frames to be selected may be taken as second target frequency-domain signals; a plurality of pieces of coherence information between the first target frequency-domain signal and the second target frequency-domain signals may be calculated separately; the step of selecting a signal in the target time frame from the first frequency-domain signal as a first target frequency-domain signal may be returned, until a plurality of pieces of coherence information in all of the target time frames in the current moment are obtained; and/or coherence information with a maximum coherence value may be selected from all of the coherence information as the coherence extremum information; the first-order differential value potentially changing over time between the coherence extremum information at the current moment and the coherence extremum information at the previous moment may be calculated to obtain the coherence change information; the coherence change information may be mapped into the update coefficient according to the first preset mapping relationship, the update coefficient may be used to characterize the proportion of the canceller parameters before update to the updated canceller parameters; the actually played audio of the audio apparatus at the previous moment may be filtered according to the updated canceller parameters to obtain the feedback sound signal at the current moment; and the feedback sound signal may be subtracted from the pre-played audio signal of the audio apparatus, and amplification may be performed to obtain the actually played audio of the audio apparatus at the current moment.

The update rate of the canceller parameters may be adjusted flexibly in real time according to the change intensity of the feedback path, thus realizing the real-time tracking of the parameter estimation of the adaptive feedback canceller, which can ensure that the parameter estimation of the adaptive feedback canceller can be always tracked properly. Therefore, performing the echo cancellation on the pre-played audio signal of the audio apparatus according to the updated canceller parameters may avoid a situation where the echo cancellation is not thorough when the feedback path from the speaker to the microphone changes drastically. This may reduce a probability of the howling phenomenon of the audio apparatus.

Although various steps in the flowcharts are illustrated in an order indicated by the arrows, these steps need not be performed in the order indicated by the arrows. There is no strict order restriction on execution of these steps, and these steps may be performed in other orders. Furthermore, at least some of the steps in the flowcharts may include multiple steps or multiple stages, and these steps or stages might not be executed at the same time and/or may be executed at different times. These steps or stages are also not necessarily sequential in an execution order, but may be executed in turn or alternately with other steps or at least part of steps or stages in the other steps.

An audio processing device for implementing the audio processing method described above is further provided herein. This audio processing device may share some of the same improvements provided with respect to the method(s) discussed herein.

As shown in FIG. 4, an audio processing device may be provided, which is applied to an audio apparatus. The audio apparatus may be provided with a feedforward microphone, a feedback microphone and an adaptive feedback canceller. The device may include an acquisition module 502, a parameter update module 504 and/or an echo cancellation module 506.

The acquisition module 502 may be configured to acquire a first sound signal collected by the feedforward microphone and a second sound signal collected by the feedback microphone.

The parameter update module 504 may be configured to detect coherence change information between the first sound signal and the second sound signal and update canceller parameters of the adaptive feedback canceller according to the coherence change information.

The echo cancellation module 506 may be configured to perform echo cancellation on a pre-played audio signal of the audio apparatus according to the updated canceller parameters to obtain an actually played audio of the audio apparatus.

The parameter update module may be configured to convert the first sound signal into a first frequency-domain signal, and/or convert the second sound signal into a second frequency-domain signal; and/or generate coherence change information according to coherence information between the first frequency-domain signal and the second frequency-domain signal.

The parameter update module may be additionally and/or alternatively configured to determine coherence extremum information at a current moment from the coherence information between the first frequency-domain signal and the second frequency-domain signal according to time delay range information between the feedforward microphone and the feedback microphone; and/or generate coherence change information according to the coherence extremum information at the current moment and coherence extremum information at a previous moment.

The parameter update module may be additionally and/or alternatively configured to determine a current moment when the first sound signal and the second sound signal are collected; calculate coherence information between the first frequency-domain signal and the second frequency-domain signal at the current moment; and/or differentiate a coherence value at the current moment and coherence information at a previous moment to obtain coherence change information.

The parameter update module may be additionally and/or alternatively configured to determine parameter update information of the adaptive feedback canceller according to the coherence change information; and/or update canceller parameters of the adaptive feedback canceller according to the parameter update information which is used to control an update rate of the canceller parameters.

The parameter update information may include an update coefficient, and the parameter update module may be additionally and/or alternatively configured to map the coherence change information into the update coefficient according to a first preset mapping relationship, in which the update coefficient may be used to characterize a proportion of canceller parameters before update to the updated canceller parameters.

The parameter update information may include an update step size, and the parameter update module may be further configured to map the coherence change information into an update step size of the canceller parameters at a current moment according to a second preset mapping relationship.

The echo cancellation module may be configured to estimate a feedback sound signal at a current moment according to the updated canceller parameters and/or an actually played audio of the audio apparatus at a previous moment; and/or differentiate the feedback sound signal and the pre-played audio signal of the audio apparatus to obtain an actually played audio of the audio apparatus at the current moment.

The modules in the above audio processing device may be implemented in whole or in part by software, hardware, and/or combinations thereof. The above modules may be embedded in or independent of the processor in the audio apparatus in a hardware form, and/or stored in a memory in the audio apparatus in a software form (e.g., so that the processor can call and execute operations corresponding to the above modules).

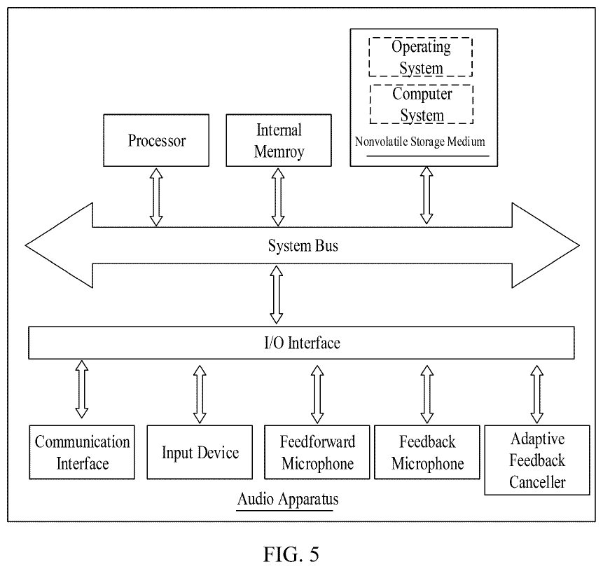

An audio apparatus is provided, with an internal structure diagram shown in FIG. 5. The audio apparatus may include a feedforward microphone, a feedback microphone, an adaptive feedback canceller, a processor, a memory and/or a communication interface, which may be connected by a system bus. The processor of the audio apparatus may be configured to provide computing and control capabilities. The memory of the audio apparatus may include a nonvolatile storage medium and/or an internal memory. The nonvolatile storage medium may store an operating system and/or a computer program. The internal memory may provide an environment for execution of the operating system and computer program in the nonvolatile storage medium. The communication interface of the audio apparatus may be configured to communicate with external terminals in a wired or wireless mode. The wireless mode may be realized by WIFI, mobile cellular network, NFC (Near Field Communication) or other technologies. The computer program, when executed by a processor, may implement an audio processing method.

The structure shown in FIG. 5 is only an illustrative block diagram of part of the structure related to solutions described in this disclosure, and does not constitute a limitation on the audio apparatus to which solutions of this disclosure are applied. An audio apparatus may include more or less components than those shown in the figure, or combine some components, and/or have different component arrangements.

An audio apparatus is provided, which may include a feedforward microphone, a feedback microphone, an adaptive feedback canceller, a memory, and/or a processor. The memory may store a computer program, and the processor may perform steps such as acquiring a first sound signal collected by the feedforward microphone and a second sound signal collected by the feedback microphone; detecting coherence change information between the first sound signal and the second sound signal, and updating canceller parameters of the adaptive feedback canceller according to the coherence change information; and/or performing echo cancellation on a pre-played audio signal of the audio apparatus according to the updated canceller parameters to obtain an actually played audio of the audio apparatus.

The processor may further perform the following steps: converting the first sound signal into a first frequency-domain signal, and/or converting the second sound signal into a second frequency-domain signal; and/or generating coherence change information according to coherence information between the first frequency-domain signal and the second frequency-domain signal.

The processor may implement the following steps when executing the computer program: determining coherence extremum information at a current moment from the coherence information between the first frequency-domain signal and/or the second frequency-domain signal according to time delay range information between the feedforward microphone and the feedback microphone; and/or generating coherence change information according to the coherence extremum information at the current moment and coherence extremum information at a previous moment.

The processor may implement the following steps when executing the computer program determining a current moment when the first sound signal and the second sound signal are collected; calculating coherence information between the first frequency-domain signal and/or the second frequency-domain signal at the current moment; and/or differentiating a coherence value at the current moment and coherence information at a previous moment to obtain coherence change information.

The processor may implement the following steps when executing the computer program determining parameter update information of the adaptive feedback canceller according to the coherence change information; and/or updating canceller parameters of the adaptive feedback canceller according to the parameter update information which is used to control an update rate of the canceller parameters.

The parameter update information may include an update coefficient, and the processor may additionally and/or alternatively implement the following steps when executing the computer program: mapping the coherence change information into the update coefficient according to a first preset mapping relationship, in which the update coefficient is used to characterize a proportion of canceller parameters before update to the updated canceller parameters.

The parameter update information may include an update step size, and the processor may additionally and/or alternatively implement the following steps when executing the computer program: mapping the coherence change information into an update step size of the canceller parameters at a current moment according to a second preset mapping relationship.

The processor may additionally and/or alternatively implement the following steps when executing the computer program: estimating a feedback sound signal at a current moment according to the updated canceller parameters and/or an actually played audio of the audio apparatus at a previous moment; and/or differentiating the feedback sound signal and the pre-played audio signal of the audio apparatus to obtain an actually played audio of the audio apparatus at the current moment.

A computer-readable storage medium with a computer program stored thereon may, when executed by a processor, implement one or more of the steps described above.

Additionally and/or alternatively, a computer program product may be provided, such as a computer program which may implement one or more of the steps described above, such as when executed by a processor.

All or part of the methods described herein may be completed by instructing related hardware through computer programs which may be stored in a nonvolatile computer-readable storage medium, and may include one or more steps of the herein described method(s) when executed. Any reference to a memory, database, or other media used herein may include at least one of nonvolatile and volatile memories. The nonvolatile memory may include a read-only memory (ROM), a magnetic tape, a floppy disk, a flash memory, an optical memory, a high-density embedded nonvolatile memory, a resistive random access memory (ReRAM), a magnetoresistive random access memory (MRAM), a ferroelectric random access memory (FRAM), a phase change memory (PCM), a graphene memory, or the like. The volatile memory may include a random access memory (RAM), an external cache memory, or the like. As description but not limitation, the RAM may be in various forms, such as a static random-access memory (SRAM) or a dynamic random access memory (DRAM). Databases described herein may include at least one of a relational database and a non-relational database. The non-relational database may include, but are not limited to, a blockchain-based distributed database. Processors described herein may be, but are not limited to, general processors, central processing units, graphics processors, digital signal processors, programmable logic devices, data processing logic devices based on quantum computing, or the like.

Various technical features described above may be combined. Not all possible combinations of the technical features described herein are listed and/or otherwise described for the purposes of conciseness. However, any combinations of the features described herein are within the scope of the description.

The examples described above represent only several examples of the present disclosure, which are described in detail but should not be construed as limitations of the scope of the disclosure. Countless variations and improvements may be made without departing from the spirit of the disclosure for those skilled in the art, all of which fall within the protection scope of the present disclosure. Accordingly, the protection scope of the present disclosure should be subject to the appended claims.

What is claimed is:

1. An audio processing method comprising:
acquiring, from a feedforward microphone of an audio apparatus, a first sound signal;
acquiring, from a feedback microphone of the audio apparatus, a second sound signal;
detecting coherence change information between the first sound signal and the second sound signal;
updating, based on the coherence change information, canceller parameters of an adaptive feedback canceller of the audio apparatus; and
performing, based on the updated canceller parameters, echo cancellation on a pre-played audio signal of the audio apparatus to obtain an actually played audio of the audio apparatus.

2. The method of claim 1, wherein the detecting the coherence change information comprises:
converting the first sound signal into a first frequency-domain signal;
converting the second sound signal into a second frequency-domain signal; and
generating coherence change information according to coherence information between the first frequency-domain signal and the second frequency-domain signal.

3. The method of claim 1, wherein the detecting the coherence change information comprises:
determining, based on time delay range information between the feedforward microphone and the feedback microphone and for a current time, coherence extremum information from the coherence information between the first sound signal and the second sound signal; and
generating coherence change information according to the coherence extremum information at the current time and coherence extremum information at a previous time.

4. The method of claim 1, wherein the detecting the coherence change information comprises:
determining a current time when the first sound signal and the second sound signal are collected;
calculating coherence information between the first sound signal and the second sound signal at the current time; and
differentiating a coherence value at the current time and coherence information at a previous time to obtain coherence change information.

5. The method of claim 1, wherein the updating the canceller parameters is based on parameter update information, wherein the parameter update information is used to control an update rate of the canceller parameters.

6. The method of claim 1, wherein the updating the canceller parameters is based on parameter update information, wherein the parameter update information comprises at least one of an update coefficient and an update step size, and wherein the method further comprises determining the parameter update information by one or more of:
mapping, based on a first preset mapping relationship, the coherence change information to the update coefficient, wherein the update coefficient is used to characterize a proportion of canceller parameters before update to the updated canceller parameters; and
mapping, based on a second preset mapping relationship, the coherence change information to an update step size of the canceller parameters at a first time.

7. The method of claim 1, wherein the performing the echo cancellation comprises:
estimating, based on the updated canceller parameters and an actually played audio of the audio apparatus at a previous time, a feedback sound signal at a current time; and
differentiating the feedback sound signal and the pre-played audio signal of the audio apparatus to obtain an actually played audio of the audio apparatus at the current time.

8. An audio processing device comprising:
an acquisition module configured to:
acquire, from a feedforward microphone of an audio apparatus, a first sound signal; and
acquire, from a feedback microphone of the audio apparatus, a second sound signal;
a parameter update module configured to:
detect coherence change information between the first sound signal and the second sound signal; and
update, based on the coherence change information, canceller parameters of an adaptive feedback canceller of the audio apparatus; and
an echo cancellation module configured to:
perform, based on the updated canceller parameters, echo cancellation on a pre-played audio signal of the audio apparatus to obtain an actually played audio of the audio apparatus.

9. The audio processing device of claim 8, wherein the parameter update module is configured to detect the coherence change information by performing the following steps:
converting the first sound signal into a first frequency-domain signal;
converting the second sound signal into a second frequency-domain signal; and
generating coherence change information according to coherence information between the first frequency-domain signal and the second frequency-domain signal.

10. The audio processing device of claim 8, wherein the parameter update module is configured to detect the coherence change information by performing the following steps:
determining, based on time delay range information between the feedforward microphone and the feedback microphone and for a current time, coherence extremum information from the coherence information between the first sound signal and the second sound signal; and
generating coherence change information according to the coherence extremum information at the current time and coherence extremum information at a previous time.

11. The audio processing device of claim 8, wherein the parameter update module is configured to detect the coherence change information by performing the following steps:
determining a current time when the first sound signal and the second sound signal are collected;
calculating coherence information between the first sound signal and the second sound signal at the current time; and
differentiating a coherence value at the current time and coherence information at a previous time to obtain coherence change information.

12. The audio processing device of claim 8, wherein the parameter update module is configured to update the canceller parameters based on parameter update information, wherein the parameter update information is used to control an update rate of the canceller parameters.

13. The audio processing device of claim 8, wherein the parameter update module is configured to update the canceller parameters based on parameter update information, wherein the parameter update information comprises at least one of an update coefficient and an update step size, and wherein the parameter update information is determined by one or more of:
mapping, based on a first preset mapping relationship, the coherence change information to the update coefficient, wherein the update coefficient is used to characterize a proportion of canceller parameters before update to the updated canceller parameters; and
mapping, based on a second preset mapping relationship, the coherence change information to an update step size of the canceller parameters at a first time.

14. The audio processing device of claim 8, wherein the echo cancellation module is configured to perform the echo cancellation by performing the following steps:
estimating, based on the updated canceller parameters and an actually played audio of the audio apparatus at a previous time, a feedback sound signal at a current time; and
differentiating the feedback sound signal and the pre-played audio signal of the audio apparatus to obtain an actually played audio of the audio apparatus at the current time.

15. One or more non-transitory computer-readable media storing instructions that, when executed by one or more processors, cause an audio processing device to perform steps comprising:
acquiring, from a feedforward microphone of an audio apparatus, a first sound signal;
acquiring, from a feedback microphone of the audio apparatus, a second sound signal;
detecting coherence change information between the first sound signal and the second sound signal;
updating, based on the coherence change information, canceller parameters of an adaptive feedback canceller of the audio apparatus; and
performing, based on the updated canceller parameters, echo cancellation on a pre-played audio signal of the audio apparatus to obtain an actually played audio of the audio apparatus.

16. The one or more non-transitory computer-readable media of claim 15, wherein the detecting the coherence change information comprises:
converting the first sound signal into a first frequency-domain signal;
converting the second sound signal into a second frequency-domain signal; and
generating coherence change information according to coherence information between the first frequency-domain signal and the second frequency-domain signal.

17. The one or more non-transitory computer-readable media of claim 15, wherein the detecting the coherence change information comprises:
determining, based on time delay range information between the feedforward microphone and the feedback microphone and for a current time, coherence extremum information from the coherence information between the first sound signal and the second sound signal; and
generating coherence change information according to the coherence extremum information at the current time and coherence extremum information at a previous time.

18. The one or more non-transitory computer-readable media of claim 15, wherein the detecting the coherence change information comprises:
determining a current time when the first sound signal and the second sound signal are collected;
calculating coherence information between the first sound signal and the second sound signal at the current time; and
differentiating a coherence value at the current time and coherence information at a previous time to obtain coherence change information.

19. The one or more non-transitory computer-readable media of claim 15, wherein the updating the canceller parameters is based on parameter update information, wherein the parameter update information is used to control an update rate of the canceller parameters.

20. The one or more non-transitory computer-readable media of claim 15, wherein the updating the canceller parameters is based on parameter update information, wherein the parameter update information comprises at least one of an update coefficient and an update step size, and wherein the instructions, when executed by the one or more processors, further causes the audio processing device to determine the parameter update information by one or more of:
mapping, based on a first preset mapping relationship, the coherence change information to the update coefficient, wherein the update coefficient is used to characterize a proportion of canceller parameters before update to the updated canceller parameters; and
mapping, based on a second preset mapping relationship, the coherence change information to an update step size of the canceller parameters at a first time.
